(19) United States
(12) Patent Application Publication
(10) Pub. No.: US 2019/0040659 A1
(43) Pub. Date: Feb. 7, 2019

(54) Motor-Vehicle Door Handle

(71) Applicant: Huf Hülsbeck & Fürst GmbH & Co. KG, Velbert (DE)

(72) Inventors: Ahmad Sabah, Southfield, MI (US); Khalid Kamal, Novi, MI (US); Suat Kaya, Novi, MI (US); Yong Sang Cho, Novi, MI (US); James Sanborn, Hudson, MI (US); Vijetha Kumar, Farmington Hills, MI (US)

(21) Appl. No.: 16/037,414

(22) Filed: Jul. 17, 2018

Related U.S. Application Data
(60) Provisional application No. 62/540,743, filed on Aug. 3, 2017.

(51) Int. Cl. E05B 81/78; E05B 85/16; G07C 9/00

(52) U.S. Cl. CPC E05B 81/78; E05B 85/16; G07C 2209/63; G07C 9/00309; G07C 9/00658

(57) ABSTRACT

A door handle for a vehicle having a closure panel moveable between an open position and a closed position relative to a body of the vehicle is disclosed. The door handle includes a housing, sensor wires, and a controller. The housing is attached to the closure panel and is movable between a home position and an articulated position. The sensor wires are disposed within the housing and include first and second wires. The controller is in communication with the first and second wires and is operable to detect a hand in a detection area disposed between the housing and the closure panel. The controller transmits an unlock or a lock command based on detection of the hand within the detection area by one of the first and second wires before the other of the first and second wires.

### CROSS REFERENCE TO RELATED APPLICATIONS

This U.S. patent application claims priority under 35 U.S.C. § 119(e) to U.S. Provisional Application 62/540,743, filed on Aug. 3, 2017, the disclosure of which is considered part of the disclosure of this application and is hereby incorporated by reference in its entirety.

### TECHNICAL FIELD

The present disclosure relates to a motor-vehicle door handle for a motor-vehicle door. More particularly, the disclosure relates to a motor-vehicle door handle having wires disposed within and operable to detect a hand of a key holder to unlock or lock a vehicle door.

### BACKGROUND

This section provides background information related to the present disclosure and is not necessarily prior art.

A door handle is an attached object or mechanism used to manually open or close a door. A motor-vehicle door handle is a door handle attached to a closure panel of a vehicle and is configured to manually open or close a door of the motor-vehicle. A vehicle's door handle may protrude from the vehicle's exterior surface or it may be streamlined into the vehicle's contour. Vehicles may include a Passive Keyless Entry System (PKES), which includes a proximity system that is triggered if a key-like transducer is within a certain distance from the vehicle. The PKES is operable to allow a key holder to unlock his or her vehicle without needing to physically push a button on a key fob associated with the vehicle. Instead, as the key holder approaches the vehicle, the vehicle senses that the key, located in a pocket, or purse, or adjacent the key holder's body, is nearing the vehicle. In some examples, when the key fob is within a vehicle's threshold “bubble” distance, the PKES may implement one of two methods to unlock the door. The first method allows the vehicle to automatically unlock when the key holder (i.e., usually a driver) is within the vehicle's “bubble.” The second method allows the vehicle to unlock only when the key holder touches a sensor associated with one of the vehicle door handles. As such, there is a continuous need to improve PKES and how the system handles unlocking and locking of the vehicles when the key holder approaches the vehicle.

### SUMMARY

This section provides a general summary of the disclosure, and is not a comprehensive disclosure of its full scope or all of its features.

One aspect of the disclosure provides a door handle for a vehicle having a closure panel that is moveable between an open position and a closed position relative to a body of the vehicle. The door handle includes a housing, sensor wires, and a controller. The housing is attached to the closure panel and is movable between a home position and an articulate position. The sensor wires are disposed within the housing and include a first wire and a second wire. The controller is in communication with the first wire and the second wire. The controller is operable to transmit an unlock command based on detection of the hand within the detection area by one of the first wire and the second wire before the other of the first wire and the second wire. In addition, the controller is operable to transmit a lock command based on detection of the hand by the other of the first wire and the second wire before the one of the first wire and the second wire.

Implementations of the disclosure may include one or more of the following optional features. In some implementations, a lock mechanism is operable to prevent movement of the closure panel from the closed position to the open position in a locked state when the door handle is moved from the home position to the articulated position. The lock mechanism may also be operable to permit movement of the closure panel from the closed position to the open position in an unlocked state when the door handle is moved from the home position to the articulated position. In some examples, the lock mechanism is moved into the locked state upon receipt of the lock command from the controller and the lock mechanism is moved into the unlocked state upon receipt of the unlock command from the controller.

In some implementations, the housing includes a first channel that receives the first wire of the sensor wires and a second channel that receives the second wire of the sensor wires. The first channel may be spaced apart and separated from the second channel. In some examples, the first channel and the second channel are defined by walls extending from a surface of the housing. The walls may be integrally formed with the housing. In some examples, the first wire and the second wire are part of the same, integral wire. The first wire may be attached to the second wire at an attachment location. The attachment location may be disposed between the first channel and the second channel.

In some examples, the door handle further includes a third channel. The third channel may be disposed between the first channel and the second channel. The wire may further include a third wire. As such, the third channel may receive the third wire. In some examples, the third channel is defined by walls extending from a surface of the housing. The walls may be integrally formed with the housing. In some examples, a foam strip houses the first, second, and third wires.

In some implementations, the housing includes a first housing portion and a second housing portion releasably attached to the first housing portion. The first and second wires may be disposed on the first housing portion or the second housing portion.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1A is a partial front perspective view of a vehicle having an exemplary door handle in a home position according to the present disclosure;

FIG. 1B is a partial front perspective view of the vehicle of FIG. 1A where the exemplary door handle is in an articulated position;

FIG. 1C is a partial front perspective view of the vehicle of FIG. 1A having an exemplary closure panel shown in an open position;

FIG. 2 is a front perspective view of the exemplary door handle of FIG. 1 having two wires;

FIG. 3 is a front exploded view of the exemplary door handle of FIG. 1;

FIG. 4 is a rear exploded view of the exemplary door handle of FIG. 1;

FIG. 5 is a front view of a portion of the door handle of FIG. 1 with part of a housing removed to show internal components of the door handle;

FIG. 6 is a cross-sectional view taken along Line 6-6 of FIG. 2;

FIG. 7 is a front perspective view of another exemplary door handle in accordance with the present disclosure;

FIG. 8 is a front exploded view of the exemplary door handle of FIG. 7;

FIG. 9 is a rear exploded view of the exemplary door handle of FIG. 7 having three wire portions;

FIG. 10 is a front view of a portion of the door handle of FIG. 7; and

FIG. 11 is a cross-sectional view taken along Line 11-11 of FIG. 7.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth, such as examples of specific components, devices, and methods, to provide a thorough understanding of configurations of the present disclosure. It will be apparent to those of ordinary skill in the art that specific details need not be employed that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as, “first,” “second,” and other numerical terms do not imply a sequence or order unless clearly indicated by the context. Thus, a first element, component, region, layer or section discussed below could be termed a second element, component, region, layer or section without departing from the teachings of the example configurations.

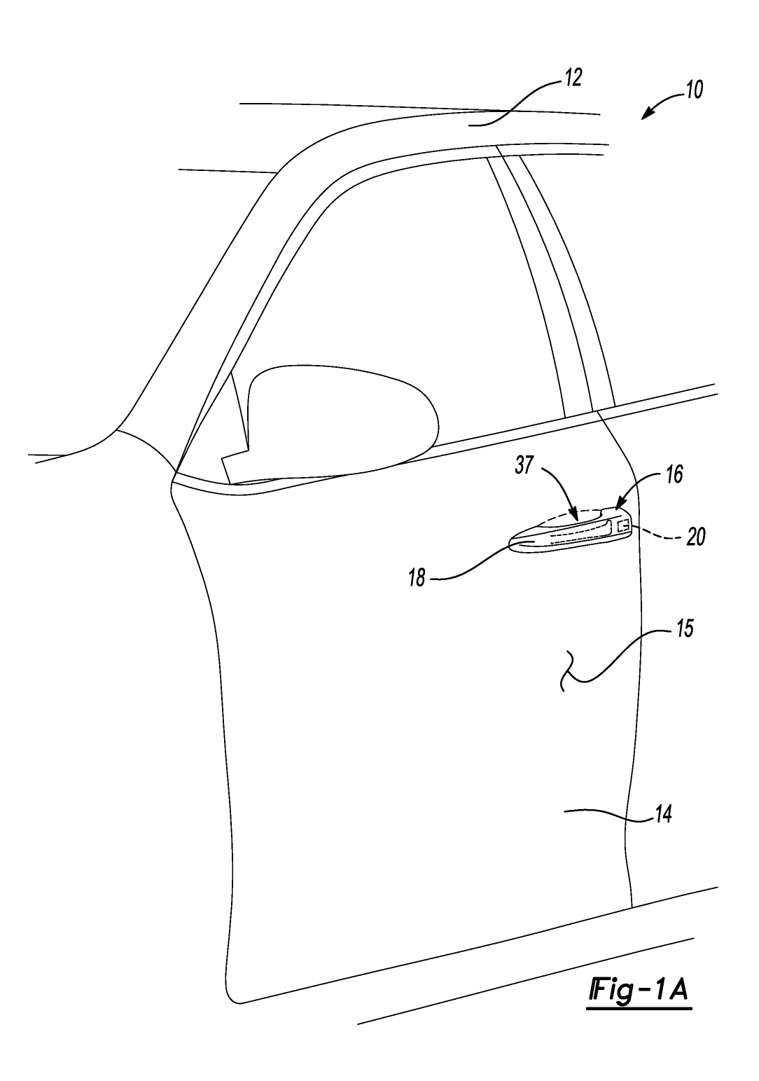

FIGS. 1A-1C illustrate a portion of a vehicle 10 that includes a vehicle body 12 and a closure panel 14. The vehicle 10 may be any motor vehicle, such as, but not limited to, a sedan, a sport-utility-vehicle (SUV), a pickup truck, a coupe, a minivan, a wagon, a hatchback, a convertible, or a van. In some examples, the closure panel 14 may be a vehicle door that is attached to the vehicle body 12 by way of hinges (none shown) on one side of the closure panel 14 that attach the closure panel 14 to the vehicle body 12. As such, the closure panel 14 moves at a pivot angle toward an outer direction from the vehicle body 12. In other examples, the closure panel 14 may be a vehicle sliding door that is attached to the vehicle by way of tracks that allow the vehicle sliding door to slide open with respect to the vehicle body 12. Other types of closure panels 14 may be used as well. The closure panel 14 may be moveable between a closed position (shown in FIGS. 1A and 1B) and an open position (shown in FIG. 1C). Referring to FIGS. 1A and 1B, when in the closed position, the closure panel 14 is positioned in such a way to prevent the driver or the passenger from entering or exiting the vehicle 10. Referring to FIG. 1C, when in the open position, the closure panel 14 is positioned in such a way to allow a driver or passenger to enter or exit the vehicle 10.

The vehicle 10 includes a door handle 16 attached to the closure panel 14 and operable to selectively permit movement of the closure panel 14 between the open position and the closed position relative to the vehicle body 12. More specifically, the door handle 16 is attached to an exterior surface 15 of the closure panel 14. In some examples, the door handle 16 protrudes from the exterior surface 15 of the closure panel 14, while in other examples, the door handle 16 is streamlined into the exterior surface 15 of the closure panel 14.

The door handle 16 includes a housing 18 attached to the closure panel 14. The door handle 16 is moveable between a home position (shown in FIG. 1A) and an articulated position (shown in FIG. 1B). A driver or passenger may apply a force on the housing 18 in a direction away from the exterior surface 15 to pull the housing 18 of the door handle 16 away from the vehicle body 12 and move the housing 18 into the articulated position.

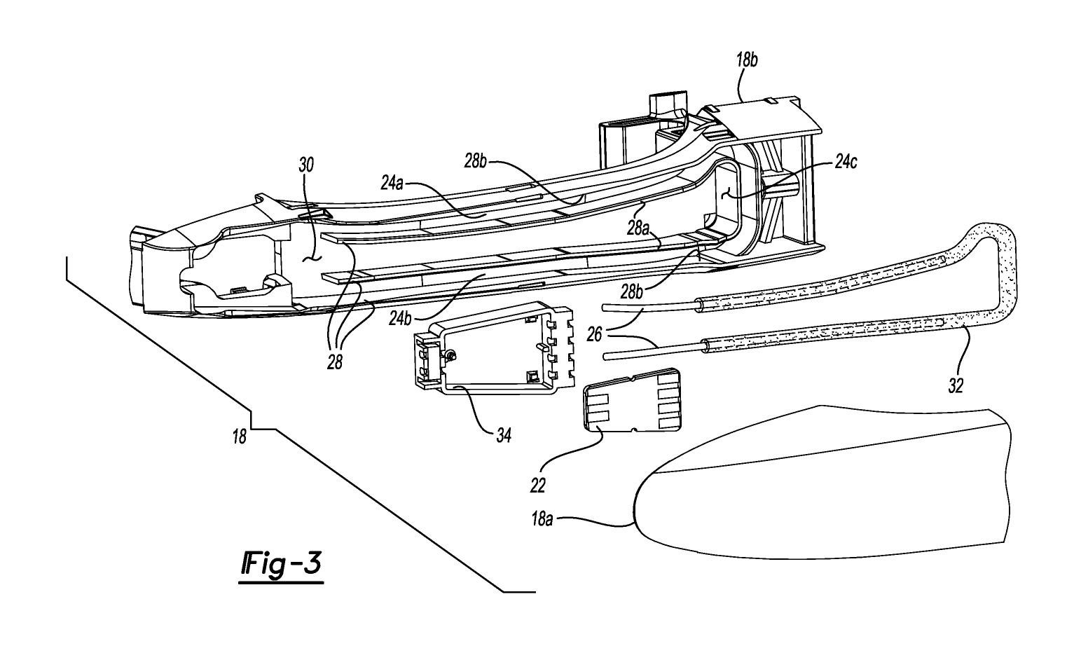

Referring to FIGS. 1A-6, in some examples, the housing 18 includes a first portion 18a (e.g., a cover) and a second portion 18b (e.g., a base). The first portion 18a and the second portion 18b of the housing 18 are releasably connected to one another and together form the housing 18 of the door handle 16.

The door handle 16 may include a lock mechanism 20 operable to prevent movement of the closure panel 14 from the closed position (FIGS. 1A and 1B) to the open position (FIG. 1C) in a locked state of the lock mechanism 20 when the door handle 16 is moved from the home position to the articulated position. In other words, when the lock mechanism 20 is in a locked state and a driver or passenger pulls the housing 18 of the door handle 16 from the home position (FIG. 1A) to the articulated position (FIG. 1B), movement of the door handle 16 from the home position to the articulated position does not cause the closure panel 14 to move from its closed position to an open position. As such, the closure panel 14 does not open when the driver or passenger pulls the housing 18 away from the closure panel 14 when the lock mechanism 20 is in the locked state. The lock mechanism 20 may permit movement of the closure panel 14 from the closed position (FIG. 1A) to the open position (FIG. 1C) in an unlocked state of the lock mechanism 20 when the door handle 16 is moved from the home position (FIG. 1A) to the articulated position (FIG. 1B). In other words, when the lock mechanism 20 is in an unlocked state and the driver or the passenger pulls the housing 18 of the door handle 16 away from the closure panel 14 (FIG. 1A) and into the articulated position (FIG. 1B), the pulling action of the driver or passenger causes the closure panel 14 to move from its closed position (FIGS. 1A and 1B) to an open position (FIG. 1C). As such, the closure panel 14 opens when the driver or passenger pulls the housing 18 away from the closure panel 14 when the lock mechanism 20 is in the unlocked state. The lock mechanism 20 may move into the locked state when it receives a lock command (e.g., from a controller 22). In other examples, the lock mechanism 20 moves into the unlocked state upon receipt of an unlock command (e.g., from the controller 22).

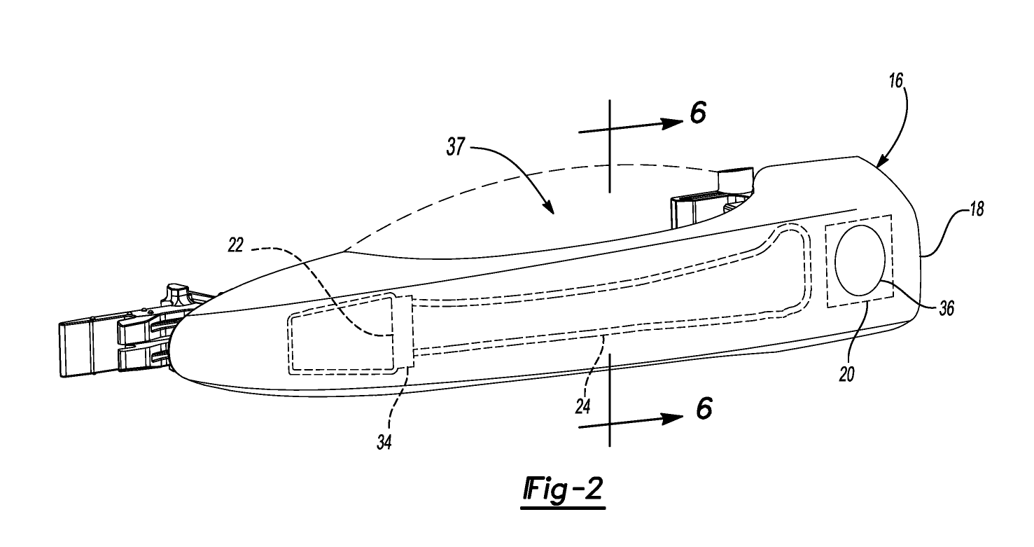

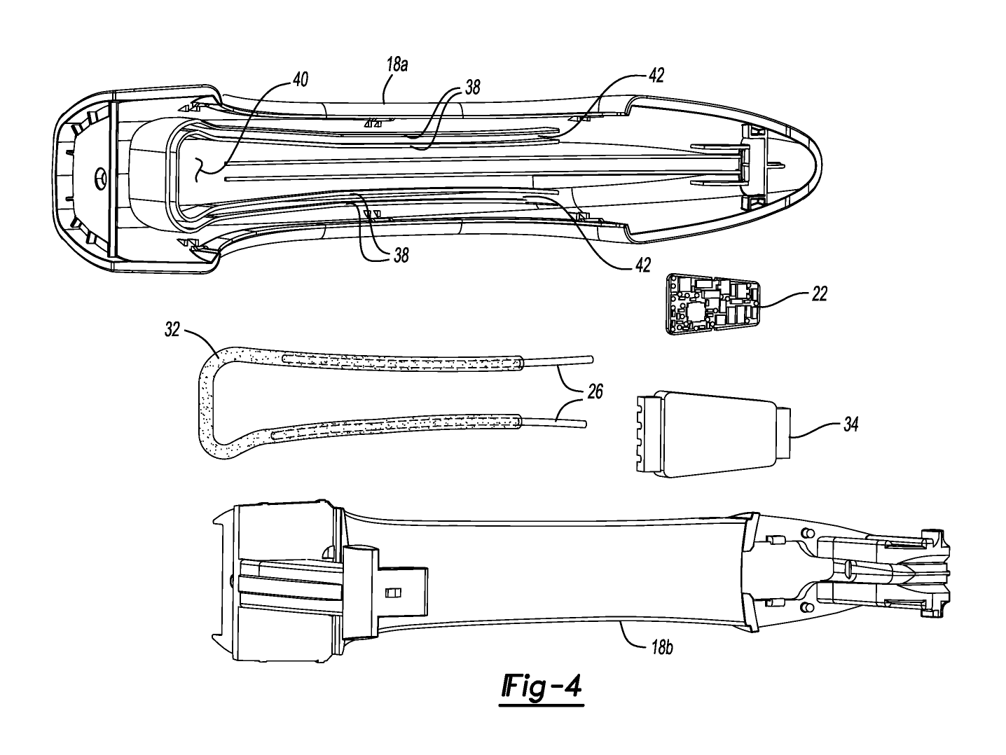

In some implementations, the housing 18 includes a first channel 24a and a second channel 24b, each configured to receive a sensor wire 26. In some examples, the first channel 24a is spaced apart and separated from the second channel 24b. As shown, the first channel 24a and the second channel 24b are defined by walls 28, 28a, 28b extending from a surface 30 of the second portion 18b of the housing 18. While the first channel 24a and the second channel 24b are shown as being defined by walls 28, 28a, 28b of the second portion 18b, the first channel 24a and the second channel 24b could alternatively be defined by walls 28, 28a, 28b extending from a surface 40 of the first portion 18a of the housing 18. Further, the first channel 24a and the second channel 24b may be defined by walls 28, 28a, 28b extending from the surface 40 of the first portion 18a of the housing 18 and the walls 28, 28a, 28b extending from the surface 30 of the second portion 18b of the housing 18, the combination of which forms the first channel 24a and the second channel 24b. In a configuration where both portions 18a, 18b of the housing 18 include walls 28, 28a, 28b defining the first channel 24a and the second channel 24b, one of the surfaces 30, 40 may include at least one wall 38 (FIG. 4) that holds the sensor wires 26 in position when the first portion 18a of the housing 18 and the second portion 18b of the housing 18 are connected (FIG. 6). In some examples, two walls 38 extend from the surface 30, 40 forming a third channel 42 having a channel length less than a channel length of the first and second channels 24a, 24b. In this case, the walls 38 provide an improved grip about the sensor wires 26 in the first and second channels 24a, 24b when the first portion 18a and the second portion 18b of the housing 18 are connected to one another.

In some examples, the walls are integrally formed with the housing 18 (i.e., with the first portion 18a of the housing 18 and/or the second portion 18b of the housing 18). In some examples, the first channel 24a and the second channel 24b connect at a connection channel 24c defined by walls 28. In some examples, the walls 28 defining the first, second, and connection channels 24a, 24b, 24c include an inner wall 28a and an outer wall 28b. In some examples, the inner wall 28a includes a continuous wall that defines one side of the first, second, and connection channels 24a, 24b, 24c, while the outer wall 28b includes a continuous wall that defines the other side of the first, second, and connection channels 24a, 24b, 24c. In other examples, the inner wall 28a and/or the outer wall 28b is a discontinuous wall.

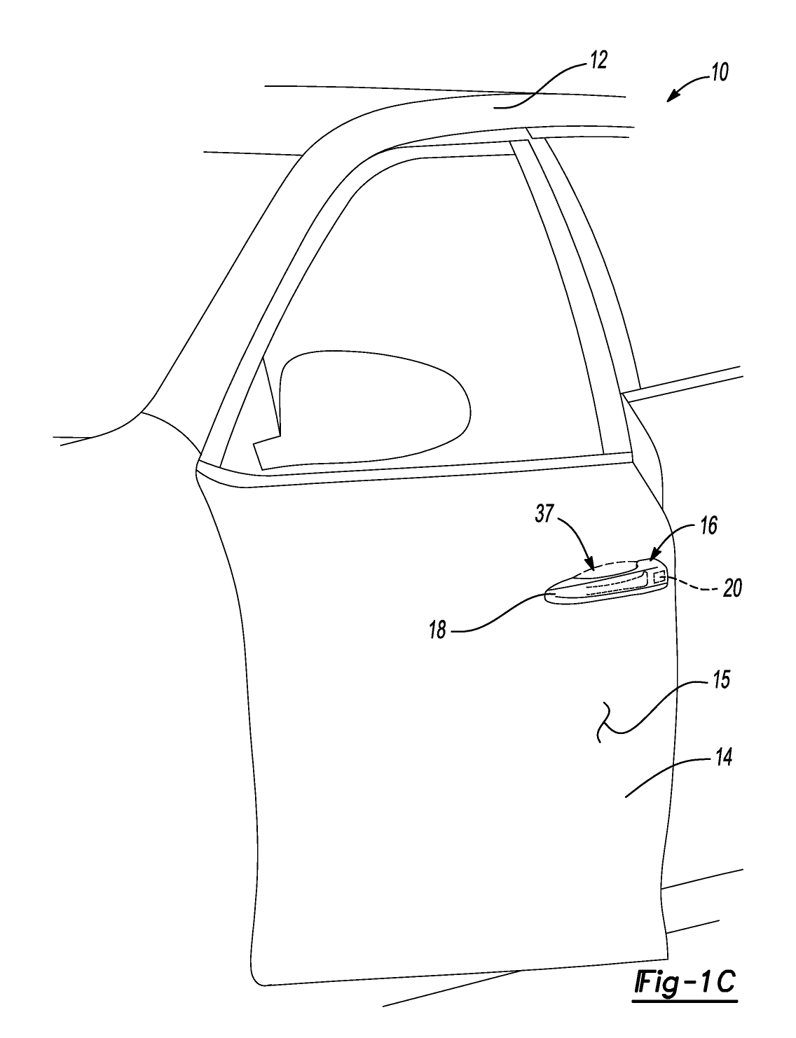

The door handle 16 may include the sensor wires 26 disposed within the housing 18 (i.e., within the first portion 18a or the second portion 18b of the housing 18). The sensor wires 26 include a first wire 26a and a second wire 26b. In some examples, the first channel 24a receives the first wire 26a and the second channel 24b receives the second wire 26b. In some examples, the first and second wires 26a, 26b of the sensor wires 26 are part of the same integral sensor wire 26 (FIG. 3). In other examples, the first wire 26a is attached to the second wire 26b at an attachment location (not shown) disposed between the first channel 24a and the second channel 24b (i.e., within the connection channel 24c).

The sensor wires 26 may be packaged within the door handle 16 using several methods. In one example, the first wire 26a is received by the first channel 24a, while the second wire 26b is received by the second channel 24b. In other examples, a cylindrical housing 32 surrounds the first wire 26a and the second wire 26b before being received by the first and second channels 24a, 24b, respectively. The cylindrical housing 32 may be a foam housing or any other protective material such as, for example, rubber or other insulating materials. In some examples, the cylindrical housing 32 may be used to retain the sensor wires 26 within first and second channels 24a, 24b. In other words, the material of the cylindrical housing 32 may be compressed when received within the channels 24a, 24b, thereby retaining the first wire 26a within the first channel 24a and retaining the second wire 26b within the second channel 24b. As such, the first and second wires 26a, 26b of the sensor wire 26 are restricted from moving relative to and within the housing 18 and remain disposed at a desired location within the channels 24a, 24b once installed in the housing 18. Finally, a cover (not shown) may extend over all or part of the channels 24a, 24b at any location along the length of the channels 24a, 24b in an effort to further retain the wires 26a, 26b within the channels 24a, 24b. For example, the cover may extend across the channels 24a, 24b between the inner wall 28a and the outer wall 28b such that the cover is attached to both walls 28a, 28b and spans at least a portion of one of the channels 24a, 24b.

The door handle 16 includes the controller 22 and a controller housing 34 that houses the controller 22. The controller 22 is in communication with the first wire 26a and the second wire 26b and is operable to detect a hand in a detection area 37 disposed between the door handle 16 (e.g., the handle housing 18) and the closure panel 14. The controller 22 is operable to transmit an unlock command to the lock mechanism 20 based on detection of the hand within the detection area 37 by one of the first wire 26a and the second wire 26b before the other of the first wire 26a and the second wire 26b. In addition, the controller 22 is operable to transmit a lock command to the lock mechanism 20 based on detection of the hand by the other of the first wire 26a and the second wire 26b before the one of the first wire 26a and the second wire 26b. In other words, considering Example 1 in Table 1 below, the controller 22 is operable to transmit a lock command to the lock mechanism 20 when the controller 22 detects a hand at the first wire 26a followed by the controller 22 detecting the hand at the second wire 26b. In this example, if the controller 22 first detects the hand at the second wire 26b then detects the hand at the first wire 26a, the controller 22 transmits the unlock command to the lock mechanism 20. Considering Example 2, the controller 22 sends a lock command to the lock mechanism 20 when the controller 22 first detects the hand at the second wire 26b and subsequently detects the hand at the first wire 26a and sends an unlock command to the lock mechanism 20 when the controller 22 first detects the hand at the first wire 26a and subsequently detects the hand at the second wire 26b. Referring to Example 3, the controller 22 may send a lock command to the lock mechanism 20 when the controller 22 detects a hand at the first wire 26a then detects the hand at the second wire 26b, or when the controller 22 detects the hand at the second wire 26b followed by detecting the hand at the first wire 26a. In this case, the controller 22 is operable to send the lock command to the lock mechanism 20 when both the first wire 26a and the second wire 26b detect the hand one after the other regardless of which wire 26a, 26b detects the hand first. Similarly, considering Example 4, the controller 22 is operable to send the unlock command to the lock mechanism 20 when both the first wire 26a and the second wire 26b detect the hand one after the other regardless of which wire 26a, 26b detects the hand first.

TABLE 1

| | Detection Sequence | | | | | | | |
|---|---|---|---|---|---|---|---|---|
| | Example 1 | | Example 2 | | Example 3 | | Example 4 | |
| First wire 26a | 1st | 2nd | 2nd | 1st | 1st | 2nd | 1st | 2nd |
| Second wire 26b | 2nd | 1st | 1st | 2nd | 2nd | 1st | 2nd | 1st |
| Command | Lock | Unlock | Lock | Unlock | Lock | Lock | Unlock | Unlock |

Table 1 describes examples of commands that the controller 22 may send to the lock mechanism 20 when the controller 22 detects a hand moving in a first direction from the first wire 26a to the second wire 26b or in a second direction from the second wire 26b to the first wire 26a. Although the commands described include a lock and an unlock command, other commands may also be available. For example, a motion of the hand in the first direction (and/or the second direction) may send a command to unlock the vehicle if it is locked, or to open the windows and/or sunroof (not shown) if the vehicle is unlocked. In addition, a motion of the hand in the second direction (and/or the first direction) may send a command to lock the vehicle 10 and close the windows and/or sunroof if the vehicle 10 is unlocked and/or the windows are open. As such, the controller 22 may be configured to send a command to the lock mechanism 20 or any other mechanisms in the vehicle 10 to execute a command.

In some examples, the controller 22 is potted inside the controller housing 34. Potting is a process of filing a complete electronic assembly with a solid or gelatinous compound for resistance to shock and vibration, and for exclusion of moisture and corrosive agents. Thermoset plastics and/or silicone rubber gels may be used. For example, silicone or epoxy may be used to protect the sensor wires 26 from impact and movement relative to the housing 18 during use.

The door handle 16 may include a lock switch 36 that allows the driver or passenger to lock or unlock the vehicle 10. For example, the lock switch 36 may be used to lock the vehicle 10 while the wires 26a, 26b are used to unlock the vehicle 10. The lock switch 36 may be a tact switch or a capacitive switch. Tact switches are tactile electromechanical switches that may be used for keyboards, keypads, instruments or interface control panel applications. Tact switches are operable to react to a driver or passenger's interaction with the switch (i.e., when the tact switch is depressed) when it makes contact with a control panel (not shown) beneath the switch, which is in communication with the controller 22. As such, when the tact switch reacts to the driver or passenger's interaction with the switch, the control panel in communication with the controller 22 sends a message indicative of the interaction. As such, the controller 22 sends a lock or unlock command to the lock mechanism 20. A capacitive switch is a type of touch switch and is responsive to touch. A capacitive switch needs only one electrode to function, which may be positioned behind a non-conductive panel, such as behind the handle housing 18. The capacitive switch uses body capacitance of a user to trigger the switch.

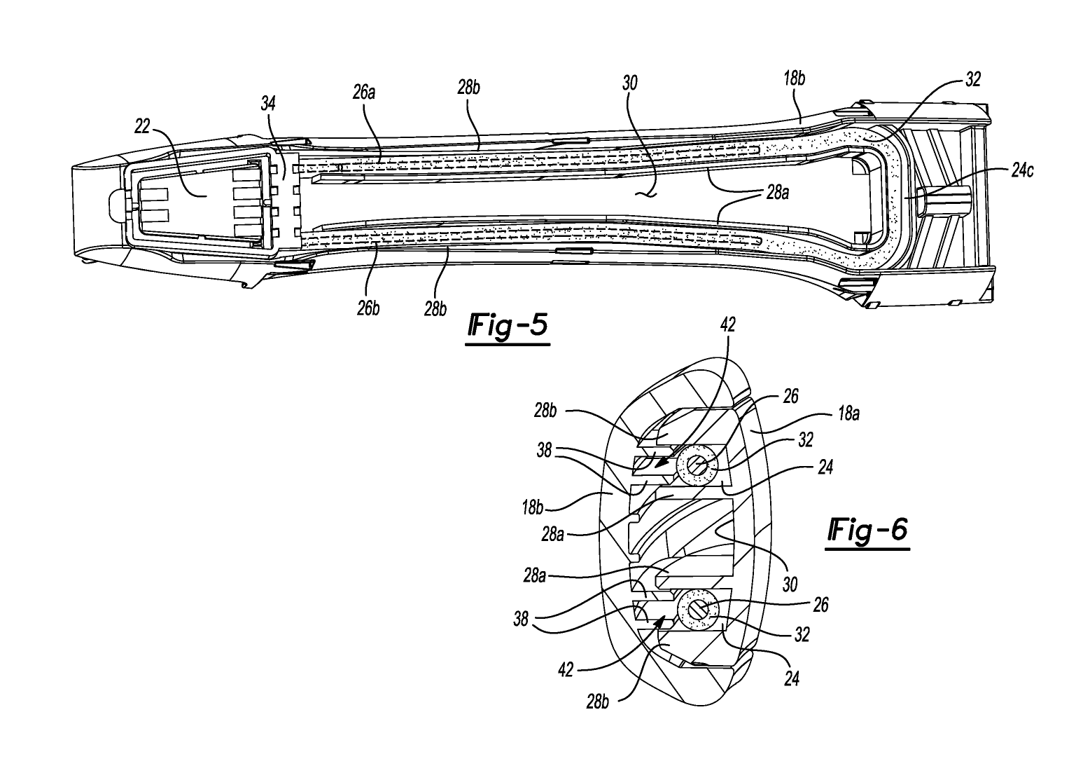

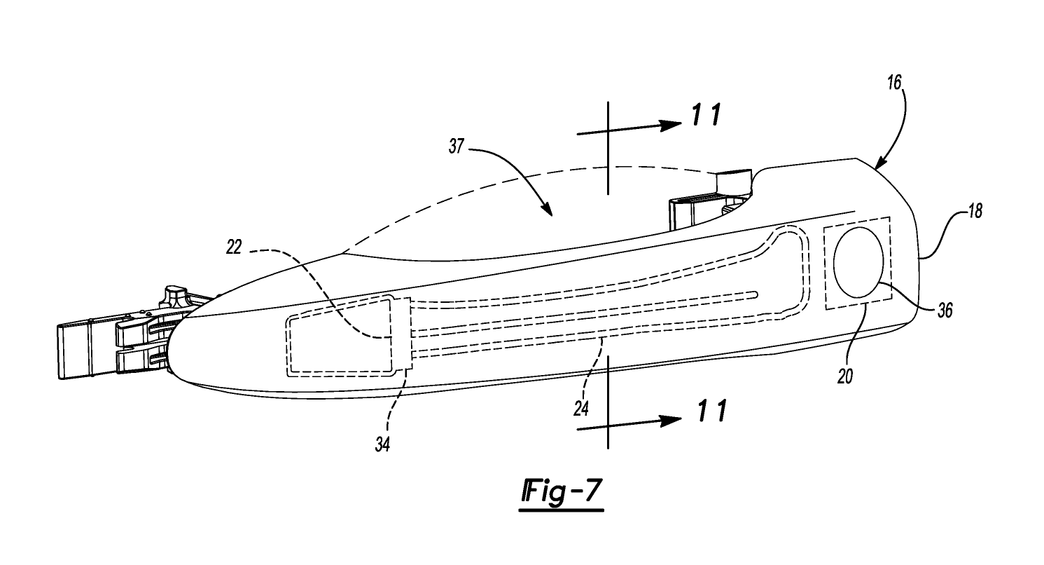

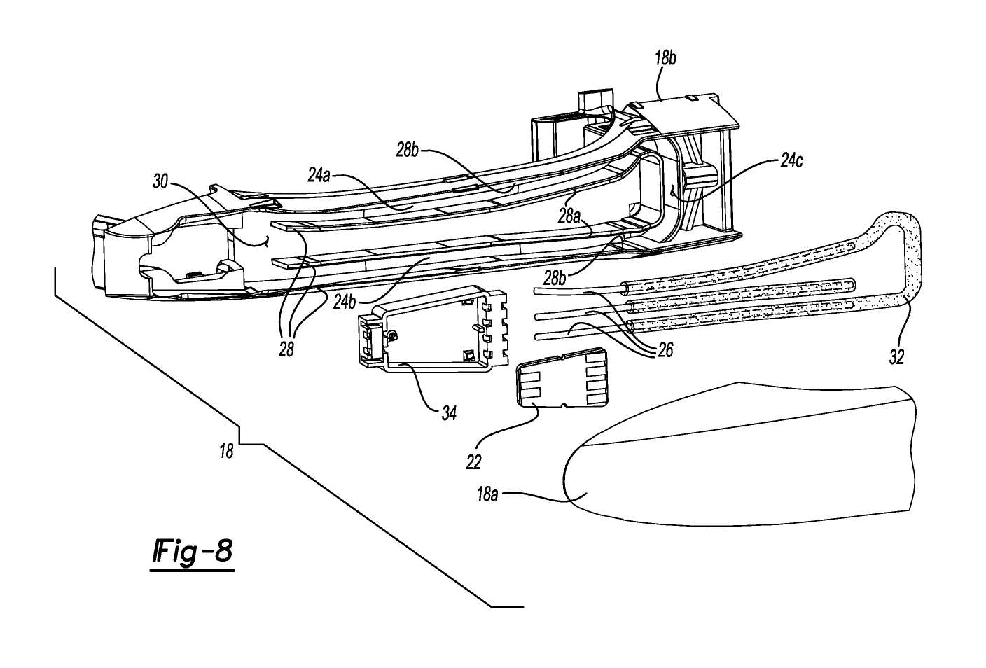

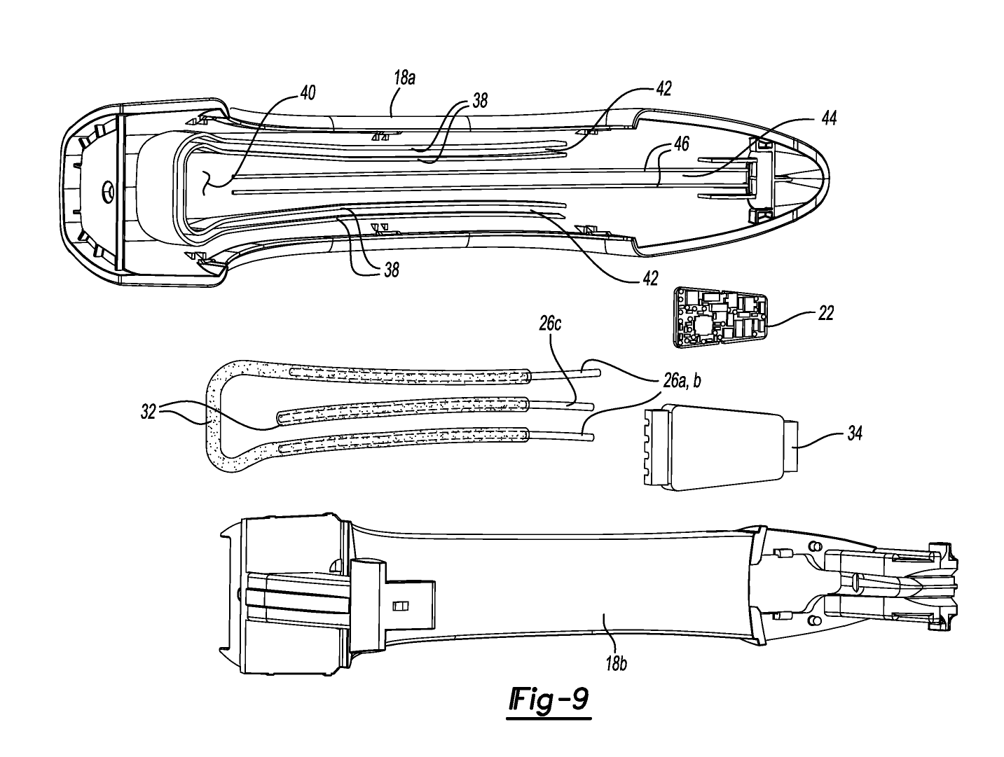

The above-described door handle 16 improves false activation by allowing the controller 22 to monitor objects that cross the sensor wires 26 (i.e., the first and second wires 26a, 26b) and, in some instances, the direction in which the object crosses (i.e., from the first wire 26a to the second wire 26b or from the second wire 26b to the first wire 26a). Referring to FIGS. 7-10, in some examples, the sensor wires 26 include a third wire 26c. The third wire 26c may act as ground and may be disposed in front of the first and second wires 26a, 26b to increase the robustness of the door handle 16.

The third wire 26c is in communication with the controller 22 and may be disposed within a fourth channel 44 on a surface 30, 40 different than the surface 30, 40 supporting the first and second wires 26a, 26b. The fourth channel 44 is defined by walls 46 extending from the surface 30, 40 of the first or second portion 18a, 18b of the housing 18 in a similar fashion as the walls 28. As with the walls 28, the fourth channel 44 formed by the walls 38 is operable to support the third wire 26c relative to and within the housing 18.

As previously described, the controller 22 is in communication with the first, second, and third wires 26a, 26b, 26c. As such, the controller 22 is operable to transmit an unlock command to the lock mechanism based on detection of a hand within the detection area 37 by one of the first, second, and third wires 26a, 26b, 26c before the another one of the first, second, and third wires 26a, 26b, 26c. In addition, the controller 22 is operable to transmit a lock command to the lock mechanism 20 based on detection of the hand by the another of the first, second, and third wires 26a, 26b, 26c before the one of the first, second, and third wires 26a, 26b, 26c. In other words, considering Example 1 in Table 2 below, the controller 22 is operable to transmit a lock command to the lock mechanism 20 based on detection of the hand by the other of the first wire 26a and the second wire 26b, followed by a detection of the hand by the third wire 26c, before the one of the first wire 26a and the second wire 26b. In other words, considering Example 1 in Table 2 below, the controller 22 is operable to transmit a lock command to the lock mechanism 20 when the controller 22 detects a hand at the first portion 26a followed by the controller 22 detecting the hand at the third wire 26c before detecting the hand at the second wire 26b. In this example, if the controller 22 first detects the hand at the second wire 26b then detects the hand at the third wire 26c, followed by detecting the hand at the first wire 26a, the controller 22 transmits the unlock command to the lock mechanism 20. Considering Example 2, the controller 22 sends a lock command to the lock mechanism 20 when the controller 22 first detects the hand at the second wire 26b, followed by a detection of the hand by the third wire 26c before detection of the hand at the first wire 26a. Referring to Example 3, the controller 22 may send a lock command to the lock mechanism 20 when the controller 22 detects a hand at the first wire 26a, followed by a detection of the hand by the third wire 26c before detection of the hand at the second wire 26b, or when the controller 22 detects the hand at the second wire 26b, followed by a detection of the hand by the third wire 26c, followed by detecting the hand at the first wire 26a. In this case, the controller 22 is operable to send the lock command to the lock mechanism 20 when the first wire 26a, the third wire 26c, and the second wire 26b detect the hand one after the other regardless of which one of the first or second wire 26a, 26b detects the hand first. Similarly, considering Example 4, the controller 22 is operable to send the unlock command to the lock mechanism 20 when the first wire 26a, the third wire 26c, and the second wire 26b detect the hand one after the other regardless of which wire 26a, 26b detects the hand first.

TABLE 2

| | Detection Sequence | | | | | | | |
|---|---|---|---|---|---|---|---|---|
| | Example 1 | | Example 2 | | Example 3 | | Example 4 | |
| First wire 26a | 1st | 3rd | 3rd | 1st | 1st | 3rd | 1st | 3rd |
| Third wire 26c | 2nd | 2nd | 2nd | 2nd | 2nd | 2nd | 2nd | 2nd |
| Second wire 26b | 3rd | 1st | 1st | 3rd | 3rd | 1st | 3rd | 1st |
| Command | Lock | Unlock | Lock | Unlock | Lock | Lock | Unlock | Unlock |

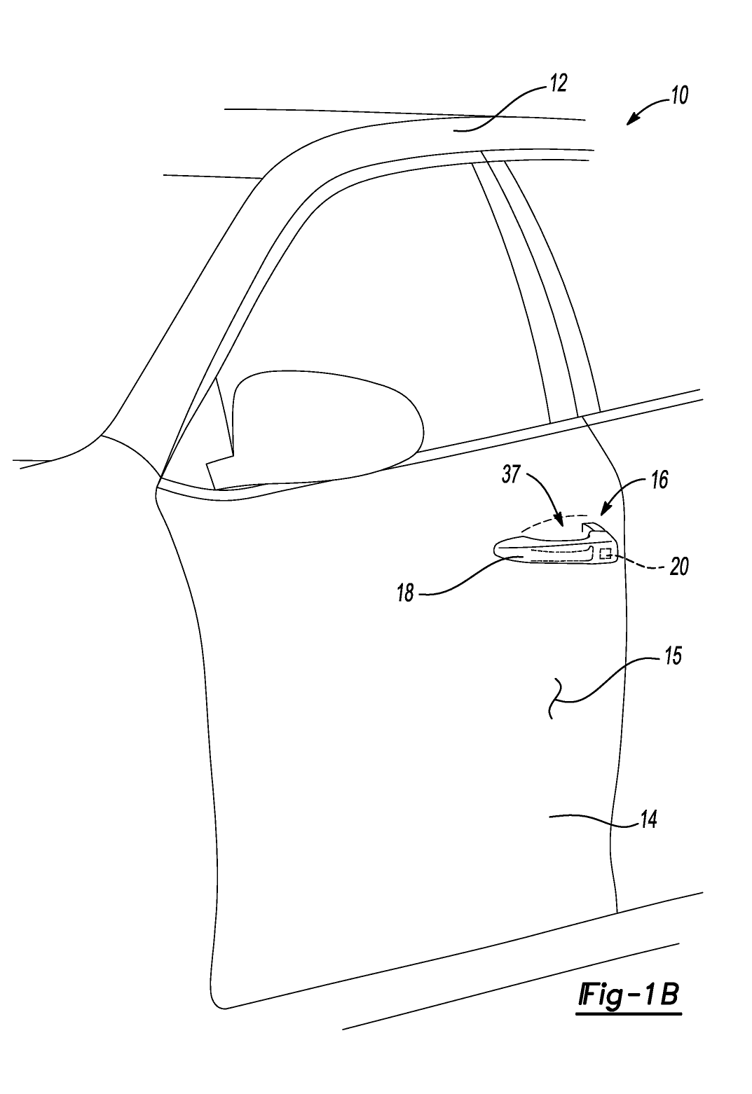

Referring back to FIGS. 1A-1B, operation of the door handle 16 having two wires as described with respect to FIGS. 2-6 or having three wires as described with respect to FIGS. 7-11 is provided. In some implementations, when the closure panel 14 is in a closed position and the lock mechanism 20 is in a locked state, the controller 22 monitors the detection area 37 for a hand. As such, when the controller 22 detects a hand in the detection area 37, the controller 22 identifies the motion of the hand with respect to the first and second wires 26a, 26b of a two-sensor-wire door handle 16 (FIGS. 2-6) or the first, second, and third wires 26a, 26b, 26c of a three-sensor-wire door handle 16 (FIGS. 7-11). As such, the controller 22 determines the wire 26a, 26b that first detected the hand from the first and second wires 26a, 26b. Once the controller 22 determines which wire 26a, 26b first detected the hand, the controller 22 then determines which command to send to the lock mechanism 20 based on the examples discussed with respect to Table 1 and Table 2 above. Once the lock mechanism 20 receives the command from the controller 22, the lock mechanism 20 may lock or unlock the vehicle 10.

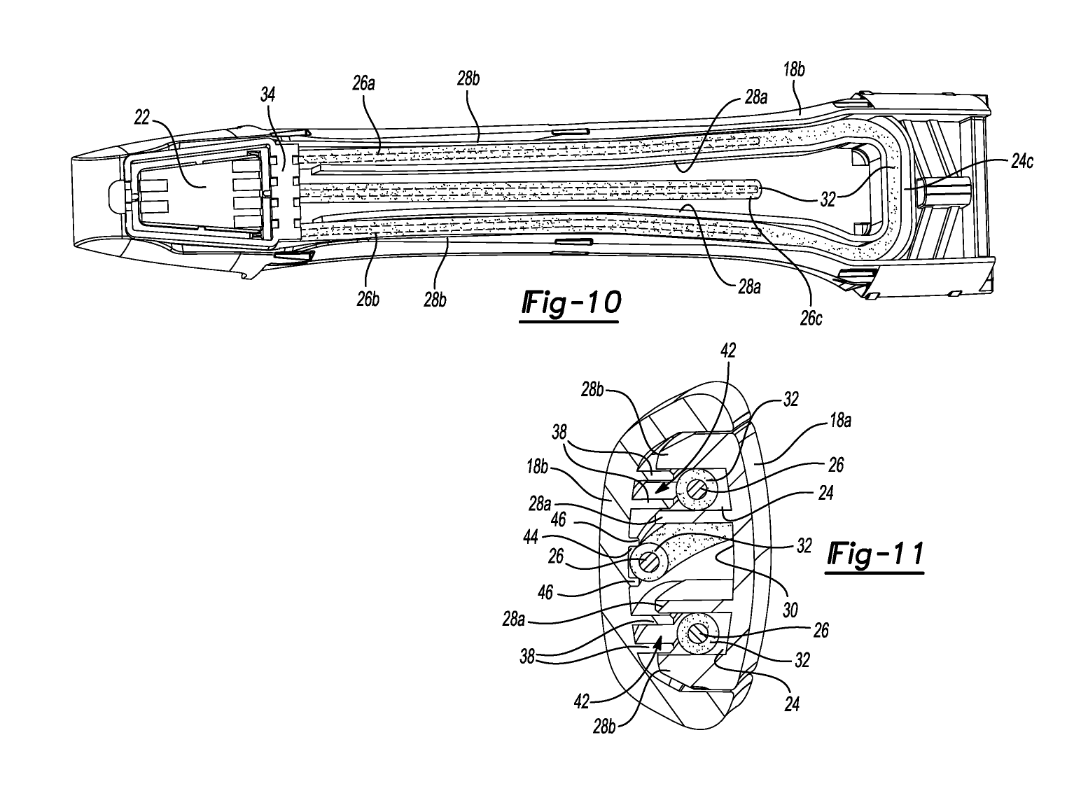

The controller 22 may additionally be able to discern when a user is in close proximity to the door handle 16 by monitoring the wires 26a, 26b, 26c. For example, if a user is disposed in close proximity to the door handle 16 but does not extend a hand into the detection area 37, the third wire 26c may be the first of the wires 26a, 26b, 26c to detect the presence of the user. In this situation, the controller 22 may be aware that someone is in the general vicinity of the door handle 16 but may determine that the user is disposed outside of the door handle 16, as the third wire 26c first detects the user (i.e., before the first wire 26a and the second wire 26b). In this situation, the controller 22 would not unlock the closure panel 14 but, rather, would maintain the closure panel 14 in its current state (i.e., locked or unlocked). The third wire 26c is permitted to detect a user located proximate to the door handle 16 near the housing 18 before the first wire 26a or the second wire 26b, as the third wire 26c is located within the housing 18 closer to an outer surface of the first portion 18a than either the first wire 26a or the second wire 26b, as shown in FIG. 11.

As described, the door handle 16 may be designed to accommodate different handle designs and provides a cost effective approach as compared to door handle assemblies incorporating conventional sensor plates. In addition, because the sensor wires 26 are lighter than conventional sensor plates, the resulting weight of the door handle 16 is less than conventional door handle assemblies. As such, the door handle 16 may incorporate a smaller counter weight when compared to conventional door handle assemblies, thereby resulting in a weight reduction for not only the door handle 16 but, also, a vehicle in which the door handle is installed. In addition to the foregoing, the location of the sensor wires 26 may be optimized based on the vehicle 10 and door handle 16, which results in an improved performance of the door handle 16. For example, because the wires 26a, 26b, 26c are malleable and can be shaped and packaged in relatively small spaces and in a variety of shapes, the wires 26a, 26b, 26c improve door handle packaging and, therefore, provides flexibility to door handle and vehicle designers.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A door handle for a vehicle having a closure panel moveable between an open position and a closed position relative to a body of the vehicle, the door handle comprising:
a housing attached to the closure panel and movable between a home position and an articulated position;
sensor wires disposed within the housing and including a first wire and a second wire; and
a controller in communication with the first wire and the second wire and operable to detect a hand in a detection area disposed between the housing and the closure panel, the controller operable to transmit an unlock command based on detection of the hand within the detection area by one of the first wire and the second wire before the other of the first wire and the second wire and operable to transmit a lock command based on detection of the hand by the other of the first wire and the second wire before the one of the first wire and the second wire.

2. The door handle of claim 1, further comprising a lock mechanism operable to prevent movement of the closure panel from the closed position to the open position in a locked state when the door handle is moved from the home position to the articulated position and operable to permit movement of the closure panel from the closed position to the open position in an unlocked state when the door handle is moved from the home position to the articulated position.

3. The door handle of claim 2, wherein the lock mechanism is moved into the locked state upon receipt of the lock command from the controller and the lock mechanism is moved into the unlocked state upon receipt of the unlock command from the controller.

4. The door handle of claim 1, wherein the housing includes a first channel receiving the first wire of the sensor wires and a second channel receiving the second wire of the sensor wires.

5. The door handle of claim 4, wherein the first channel is spaced apart and separated from the second channel.

6. The door handle of claim 4, wherein the first channel and the second channel are defined by walls extending from a surface of the housing.

7. The door handle of claim 6, wherein the walls are integrally formed with the housing.

8. The door handle of claim 4, wherein the first wire and the second wire are part of the same, integral wire.

9. The door handle of claim 4, wherein the first wire is attached to the second wire at an attachment location.

10. The door handle of claim 9, wherein the attachment location is disposed between the first channel and the second channel.

11. The door handle of claim 4, further comprising a third channel.

12. The door handle of claim 11, wherein the third channel is disposed between the first channel and the second channel.

13. The door handle of claim 12, wherein the sensor wires further include a third wire.

14. The door handle of claim 13, wherein the third channel receives the third wire.

15. The door handle of claim 13, further comprising a foam strip housing the first, second, and third wires.

16. The door handle of claim 11, wherein the third channel is defined by walls extending from a surface of the housing.

17. The door handle of claim 16, wherein the walls are integrally formed with the housing.

18. The door handle of claim 1, wherein the housing includes a first housing portion and a second housing portion releasably attached to the first housing portion, the first and second wires disposed on the first housing portion or the second housing portion.
